(19) United States
(12) Patent Application Publication
(10) Pub. No.: US 2009/0303395 A1
(43) Pub. Date: Dec. 10, 2009

(54) Apparatus and method for distributing an input signal to multiple tuners

(76) Inventor: Michael Anthony Pugel, Noblesville, IN (US)

Correspondence Address: Thomson Licensing LLC, P.O. Box 5312, Two Independence Way, PRINCETON, NJ, 08543-5312, US

(21) Appl. No.: 11/919,164

(22) PCT Filed: Apr. 26, 2006
(86) PCT No.: PCT/US2006/015891

§ 371 Date: Oct. 24, 2007

Related U.S. Application Data
(60) Provisional application No. 60/676,750, filed on May 2, 2005.

(51) Int. Cl. H04B 1/16; H04N 5/50

(52) U.S. Cl. 348/733; 455/200.1; 348/E05.097

(57) ABSTRACT

An apparatus is capable of distributing an input signal to multiple tuners within a dwelling unit using an architecture that is advantageous in terms of layout and expandability. According to an exemplary embodiment, the apparatus includes an amplifier operative to receive an input signal having a plurality of channels, and to amplify the input signal to generate an amplified signal. A plurality of serially connected couplers is operative to couple the amplified signal to a plurality of tuners.

### CROSS REFERENCE TO RELATED APPLICATION

This application claims priority to and all benefits accruing from a provisional application filed in the United States Patent and Trademark Office on May 2, 2005, and there assigned Ser. No. 60/676,750.

### BACKGROUND OF THE INVENTION

1. Field of the Invention

The present invention generally relates to signal distribution within a dwelling unit, and more particularly, to an apparatus and method capable of distributing an input signal to multiple tuners within a dwelling unit using an architecture that is advantageous in terms of layout and expandability.

2. Background Information

In a broadcast system constructed to service a multiple dwelling unit (MDU), there is an advantage to tuning all the necessary signals in one location and then allowing the distribution to each tenant to occur through some other network (e.g., lower frequency cable, Ethernet, DSL, etc.). In order to accomplish this, a receiver with multiple tuners can be employed. In a satellite broadcast system, for example, each tuner may be capable of selecting a particular transponder.

FIG. 1 is a diagram of a conventional apparatus 100 that may be used to distribute an input signal within a dwelling unit such as an MDU. Apparatus 100 of FIG. 1 includes an amplifier 10 and signal splitters 11 to 13 and employs a conventional “tree” architecture that can be used to create four outputs, each providing an input signal to a different one of four tuners (not shown). If each of the four tuners utilizes its loop through to drive a second tuner, apparatus 100 can be expanded to support eight tuners. However, this loop through arrangement cannot be repeated due to performance limitations. In order to create a condition of network transparency, some requirements are placed on the combination of amplifier 10 and splitters 11 to 13 of FIG. 1. For example, assuming that splitters 11 to 13 each provide an equal signal split with up to 5 dB loss, the gain of amplifier 10 will need to be about 6 dB (with 4-5 dB noise factor) in order for the tuner noise factor of around 10 dB to equal the system noise factor of apparatus 100. Linearity issues also need to be addressed when selecting amplifier 10.

While apparatus 100 of FIG. 1 may operate satisfactorily, its high level of symmetry places restriction on subcomponent placement in a printed circuit board layout. Additionally, in order to service more tuners, its architecture would have to be “rebuilt” from the top down (i.e., add another splitter to input, re-juggle the gain, etc.), which is completely impractical and virtually impossible after its initial fabrication and construction. Accordingly, there is a need for an apparatus and method capable of distributing an input signal, such as a signal received via satellite, to multiple tuners within a dwelling unit which avoids the foregoing problems, and thereby provides advantages over the conventional multiple splitter approach of FIG. 1 in terms of layout and expandability. The present invention addresses these and/or other issues.

### SUMMARY OF THE INVENTION

In accordance with an aspect of the present invention, an apparatus is disclosed. According to an exemplary embodiment, the apparatus comprises an amplifier operative to receive an input signal having a plurality of channels, and to amplify the input signal to generate an amplified signal. A plurality of serially connected couplers is also provided. Each coupler is operative to couple the amplified signal to a different one of a plurality of tuners.

In accordance with another aspect of the present invention, a method for distributing an input signal is disclosed. According to an exemplary embodiment, the method comprises receiving the input signal having a plurality of channels, amplifying the input signal to generate an amplified signal, providing the amplified signal to a plurality of serially connected couplers, and wherein each of the couplers couples the amplified signal to a different one of a plurality of tuners.

In accordance with another aspect of the present invention, a television signal receiver is disclosed. According to an exemplary embodiment, the television signal receiver comprises amplifying means for receiving an input signal having a plurality of channels and amplifying the input signal to generate an amplified signal. A plurality of serially connected coupling means each couple the amplified signal to a different one of a plurality of tuning means.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of a conventional apparatus for distributing an input signal within a dwelling unit;

FIG. 2 is a diagram of an apparatus for distributing an input signal within a dwelling unit according to an exemplary embodiment of the present invention;

FIG. 3 is a diagram of an apparatus for distributing an input signal within a dwelling unit according to another exemplary embodiment of the present invention; and

FIG. 4 is a flowchart illustrating steps for distributing an input signal within a dwelling unit according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

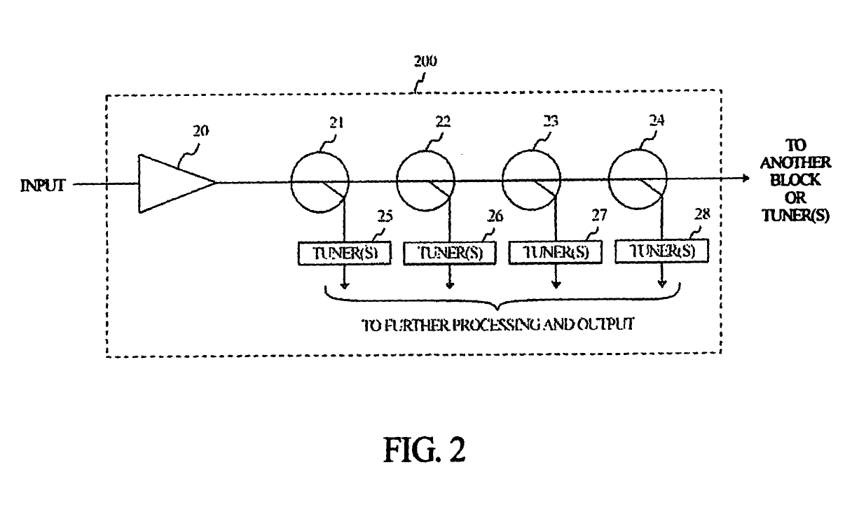

Referring now to the drawings, and more particularly to FIG. 2, a diagram of an apparatus 200 for distributing an input signal within a dwelling unit according to an exemplary embodiment of the present invention is shown.

As shown in FIG. 2, apparatus 200 comprises amplifying means such as amplifier 20, signal coupling means such as signal couplers 21 to 24, and tuning means such as tuner(s) 25 to 28. The foregoing elements of FIG. 2 may be included on one or more integrated circuits (ICs). For clarity of description, certain conventional elements associated with apparatus 200 such as certain control signals, power signals and/or other elements may not be shown in FIG. 2. According to an exemplary embodiment, apparatus 200 is embodied as a television signal receiver, and may be used in an MDU such as an apartment building, office building, or other MDU.

Amplifier 20 is operative to receive and amplify an input signal having audio and/or video content to thereby generate an amplified signal. According to an exemplary embodiment, the input signal includes a plurality of audio and/or video channels in analog and/or digital modulation formats and is received by amplifier 20 via a signal source such as a satellite, cable or other signal source. When received via satellite, the input signal may for example occupy a frequency band from approximately 950 to 2150 MHz.

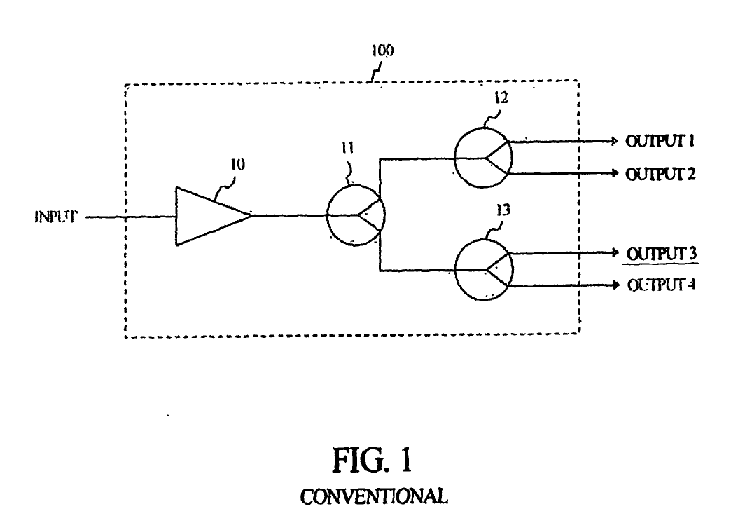

Signal couplers 21 to 24 are operative to couple the amplified signal provided from amplifier 20 to tuner(s) 25 to 28, respectively. According to an exemplary embodiment, signal couplers 21 to 24 may be embodied as directional taps that are serially connected to one another as shown in FIG. 2. Apparatus 200 of FIG. 2 replaces the three signal splitters of FIG. 1 with four signal couplers 21 to 24 with, for example, 10 dB coupling (assuming 1 dB through line loss) and allows a serial connection thereof. For purposes of example and explanation, apparatus 200 of FIG. 2 is shown with four individual signal couplers, namely signal couplers 21 to 24. However, the actual number of signal couplers included in apparatus 200 in practice may be different as a matter of design choice. Accordingly, the coupling can be customized in terms of loss and location.

Also in practice, amplifier 20 must have enough gain in order to overcome the through line loss plus the last signal coupling. This amounts to around 14 dB or so in the exemplary embodiment shown in FIG. 2. Linearity issues also need to be addressed when selecting amplifier 20. Additionally, the end of the connection line (i.e., the output of signal coupler 24 in FIG. 2) can be cascaded into a second block having the same or similar architecture of apparatus 200, or can be extended to serve one or more additional tuners. Note that cascading, amplifiers forces some additional performance constraints.

Tuner(s) 25 to 28 are each operative to perform a signal tuning function. As indicated in FIG. 2, each tuner block 25 to 28 includes one or more tuning devices. According to an exemplary embodiment, tuner(s) 25 to 28 each generate one or more tuned signals which may then be provided for further processing (e.g., demodulation, transport processing decoding, etc.) and output. In general, the architecture of apparatus 200 provides flexibility in signal routing and potential ease of expansion (i.e., adding more tuners). In other words, the serial connection of signal couplers 21 to 24 provides significant advantages over the conventional multiple splitter approach represented in FIG. 1 in terms of layout convenience and expandability.

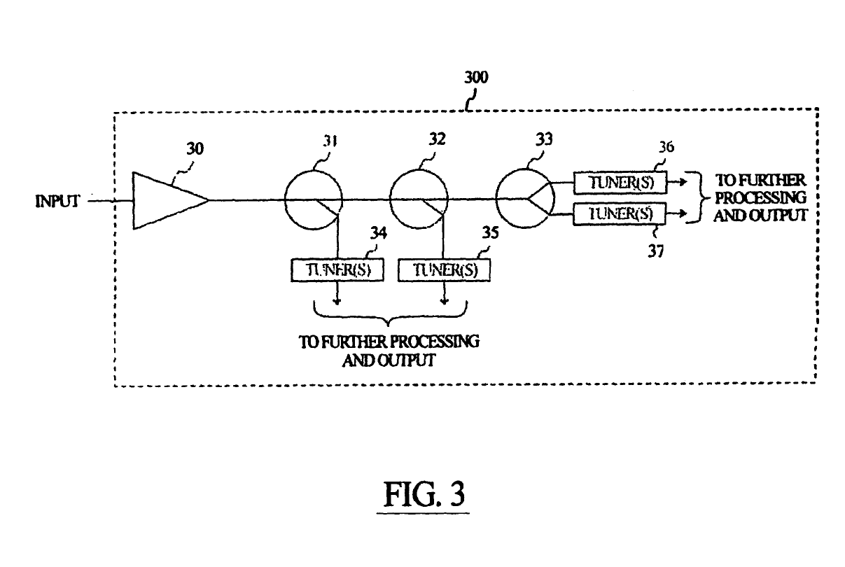

Referring to FIG. 3, a diagram of an apparatus 300 for distributing an input signal within a dwelling unit according to another exemplary embodiment of the present invention is shown. As shown in FIG. 3, apparatus 300 comprises amplifying means such as amplifier 30, signal coupling means such as signal couplers 31 and 32, signal splitting means such as signal splitter 33, and tuning means such as tuner(s) 34 to 37. The foregoing elements of FIG. 3 may be included on one or more ICs. For clarity of description, certain conventional elements associated with apparatus 300 such as certain control signals, power signals and/or other elements may not be shown in FIG. 3. According to an exemplary embodiment, apparatus 300 is embodied as a television signal receiver, and may be used in an MDU such as an apartment building, office building, or other MDU.

Amplifier 30 is operative to receive and amplify an input signal having audio and/or video content to thereby generate an amplified signal. According to an exemplary embodiment, the input signal includes a plurality of audio and/or video channels in analog and/or digital modulation formats and is received by amplifier 30 via a signal source such as a satellite, cable or other signal source. When received via satellite, the input signal may for example occupy a frequency band from approximately 950 to 2150 MHz. The performance of amplifier 30 may for example be similar to that of amplifier 20 of FIG. 2.

Signal couplers 31 and 32 are operative to couple the amplified signal provided from amplifier 30 to tuner(s) 34 and 35, respectively. According to an exemplary embodiment, signal couplers 31 and 32 may be embodied as directional taps that are serially connected to one another as shown in FIG. 3. Apparatus 300 of FIG. 3 replaces the three signal splitters of FIG. 1 with two signal couplers 31 and 32 and a single signal splitter 33. For purposes of example and explanation, apparatus 300 of FIG. 3 is shown with two Individual signal couplers, namely signal couplers 31 and 32. However, the actual number of signal couplers included, in apparatus 300 in practice may be different as a matter of design choice. Accordingly, the coupling can be customized in terms of loss and location.

Signal splitter 33 is operative to equally split the amplified signal provided from signal coupler 32 to thereby generate split signals that each correspond to the amplified signal. According to an exemplary embodiment, signal splitter 33 provides the split signals to tuner(s) 36 and 37, as indicated in FIG. 3. As referred to herein, a “signal splitter” is deemed to represent a distinctly different element than a “signal coupler.”

Tuner(s) 34 to 37 are each operative to perform a signal tuning function. As indicated in FIG. 3, each tuner block 34 to 37 includes one or more tuning devices. According to an exemplary embodiment, tuner(s) 34 to 37 each generate one or more tuned signals which may then be provided for further processing (e.g., demodulation, transport processing, decoding, etc.) and output. Like apparatus 200 of FIG. 2, the architecture of apparatus 300 of FIG. 3 provides flexibility in signal routing and potential ease of expansion (i.e., adding more tuners). It is noted that the output of signal coupler 24 of FIG. 2 can be coupled to amplifier 30 of FIG. 3 as a means for architecture expansion.

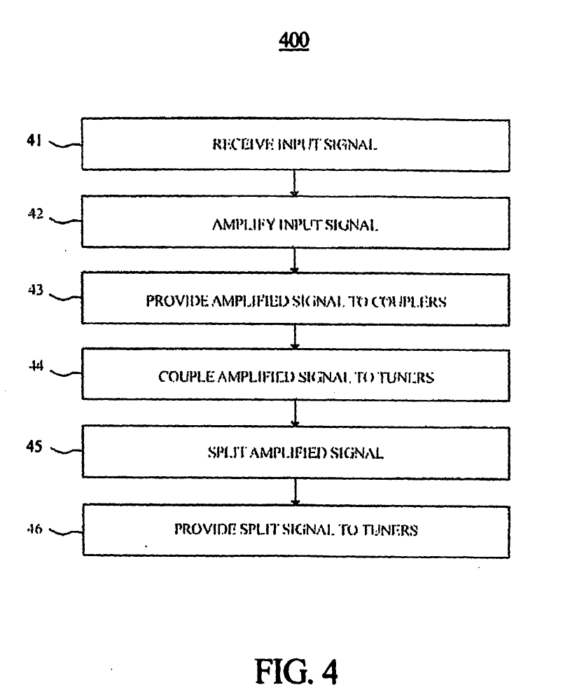

Referring now to FIG. 4, a flowchart 400 illustrating steps for distributing an input signal within a dwelling unit according to an exemplary embodiment of the present invention is shown. For purposes of example and explanation, the steps of FIG. 4 will be described with reference to apparatuses 200 and 300 of FIGS. 2 and 3 described above. The steps of FIG. 4 are exemplary only, and are not intended to limit the present invention in any manner.

At step 41, apparatus 200 or 300 receives an input signal. According to an exemplary embodiment, the input signal includes a plurality of audio and/or video channels and is received by amplifier 20, or 30 via a signal source such as a satellite, cable or other signal source. When received via satellite, the input signal may for example occupy a frequency band from approximately 0.950 to 2150 MHz.

At step 42, amplifier 20 or 30 amplifies the input signal to thereby generate an amplified signal corresponding to the input signal. Accordingly, the amplified signal includes all of the same audio and/or video content as the input signal. At step 43, the amplified signal generated by amplifier 20 or 30 is provided to signal couplers 21 to 24 or signal couplers 31 to 32, respectively. At step 44, signal couplers 21 to 24 or signal couplers 31 to 32 couple the amplified signal to tuner(s) 25 to 28 or tuner(s) 34 to 35, respectively. In the embodiment of FIG. 2, signal coupler 24 may also provide the amplified signal to another block having the same or similar architecture of apparatus 200 or apparatus 300, or to one or more additional tuners.

At step 45, signal splitter 33 splits the amplified signal to thereby generate a split signal. This step is optional as it applies to apparatus 300 of FIG. 3, and not apparatus 200 of FIG. 2. Then, at step 46, the split signal is provided to tuner(s) 36 to 37. Again, this step is optional as it applies to apparatus 300 of FIG. 3, and not apparatus 200 of FIG. 2.

As described herein, the present invention provides an apparatus and method capable of distributing an input signal to multiple tuners within a dwelling unit using an architecture that is advantageous in terms of layout and expandability. The present invention may be applicable to various apparatuses, either with or without an integrated display device. Accordingly, the phrase “television signal receiver” as used herein may refer to systems or apparatuses including, but not limited to, television sets or computers that include an integrated display device, and systems or apparatuses such as set-top boxes, computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus, comprising:
an amplifier operative to receive an input signal having a plurality of channels, and to amplify said input signal to generate an amplified signal; and
a plurality of serially connected couplers each operative to couple said amplified signal to a different one of a first plurality of tuners.

2. The apparatus of claim 1, further comprising a splitter operative to split an output signal from a last one of said couplers to provide said amplified signal to a second plurality of tuners.

3. The apparatus of claim 1, wherein said input signal is received via satellite.

4. The apparatus of claim 1, wherein said input signal occupies a frequency band from 950 to 2150 MHz.

5. The apparatus of claim 1, wherein said first plurality of tuners tune at least one of audio and video signals that are distributed within a multiple dwelling unit.

6. The apparatus of claim 1, wherein said couplers each couple said amplified signal to at least two tuners.

7. A method for distributing an input signal, comprising steps of:
receiving said input signal having a plurality of channels;
amplifying said input signal to generate an amplified signal;
providing said amplified signal to a plurality of serially connected couplers; and
wherein each said coupler couples said amplified signal to a different one of a first plurality of tuners.

8. The method of claim 7, further comprising a step of splitting an output signal from a last one of said couplers to provide said amplified signal to a second plurality of tuners

9. The method of claim 7, wherein said input signal is received via satellite.

10. The method of claim 7, wherein said input signal occupies a frequency band from 950 to 2150 MHz.

11. The method of claim 7, wherein said first plurality of tuners tune at least one of audio and video signals that are distributed within a multiple dwelling unit.

12. The method of claim 7, wherein said couplers each couples said amplified signal to at least two tuners.

13. A television signal receiver, comprising:
amplifying means for receiving an input signal having a plurality of channels, and amplifying said input signal to generate an amplified signal; and
a plurality of serially connected coupling means each for coupling said amplified signal to a different one of a first plurality of tuning means.

14. The television signal receiver of claim 13, further comprising signal splitting means for splitting an output signal from a last one of said couplers to provide said amplified signal to a second plurality of tuning means.

15. The television signal receiver of claim 13, wherein said input signal is received via satellite.

16. The television signal receiver of claim 13, wherein said input signal occupies a frequency band from 950 to 2150 MHz.

17. The television signal receiver of claim 13, wherein said first plurality of tuning means tune at least one of audio and video signals that are distributed within a multiple dwelling unit.

18. The television signal receiver of claim 13, wherein said coupling means each couple said amplified signal to at least two tuning means.
